(19) United States
(12) Patent Application Publication
(10) Pub. No.: US 2006/0195627 A1
(43) Pub. Date: Aug. 31, 2006

(54) Detecting whether video source device is coupled to video display device

(76) Inventors: James R. Cole, Albany, OR (US); P. Guy Howard, Junction, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/065,775

(22) Filed: Feb. 26, 2005

(51) Int. Cl. G06F 3/00

(52) U.S. Cl. 710/15

(57) ABSTRACT

A video display device detects whether an output port of a video source device is communicatively coupled to an input port of the video display device, based on detecting a resistance at the output port of the video source device. In response to detecting that the output port of the video source device is communicatively coupled to the input port of the video display device, and where the video source device is not currently outputting a signal at the output port, the video display device performs one or more actions.

### BACKGROUND

Projectors are display devices that project image data from a video source device onto an external surface for viewing by larger numbers of users. Projectors are commonly used with portable computers in conference rooms and other settings, so that all participants in a conference are able to view the computer screen of a portable computer. Portable computers include laptop and notebook computers, among other types of portable computers.

Such portable computers may include a VGA port or other display output port. A cable is connected between the portable computer and the projector. To activate or enable the VGA port, usually a special key sequence is entered on the keyboard of the portable computer, such as Fn-F5, or another key sequence. Even when the portable computer is on and has been connected to the projector, unless the appropriate key sequence is entered, the contents of the internal portable computer display may not be sent to the VGA port.

Often users forget to enter this key sequence, and do not know why the projector is not displaying the contents of the internal portable computer display. Furthermore, because the projector may take a few seconds to detect the signal on the VGA port, the user may enter the key sequence, not see a picture being projected by the projector, and thus erroneously enter the key sequence again, deactivating the VGA port. Such users may become frustrated, repeatedly entering the key sequence until a picture is projected by the projector, and never knowing why entering the key sequence the first time did not appear to work.

### BRIEF DESCRIPTION OF THE DRAWINGS

The drawings referenced herein form a part of the specification. Features shown in the drawing are meant as illustrative of only some embodiments of the invention, and not of all embodiments of the invention.

FIG. 1 is a diagram of a video source device communicatively connected to a video display device, according to an embodiment of the invention.

FIG. 2 is a diagram of a circuit for a video display device to detect whether a video source device is connected to the video display device when the video source device is not currently outputting a signal to the video display device, according to an embodiment of the invention.

FIG. 3 is diagram of another circuit for a video display device to detect whether a video source device is connected to the video display device when the video source device is not currently outputting a signal to the video display device, according to another embodiment of the invention.

FIG. 4 is a flowchart of a method to detect whether a video source device is connected to the video display device when the video source device is not currently outputting a signal to the video display device, according to an embodiment of the invention.

### DETAILED DESCRIPTION OF THE DRAWINGS

In the following detailed description of exemplary embodiments of the invention, reference is made to the accompanying drawings that form a part thereof, and in which is shown by way of illustration specific exemplary embodiments in which the invention may be practiced. These embodiments are described in sufficient detail to enable those skilled in the art to practice the invention. Other embodiments may be utilized, and logical, mechanical, electrical, electro-optical, software/firmware and other changes may be made without departing from the spirit or scope of the present invention. The following detailed description is, therefore, not to be taken in a limiting sense, and the scope of the present invention is defined only by the appended claims.

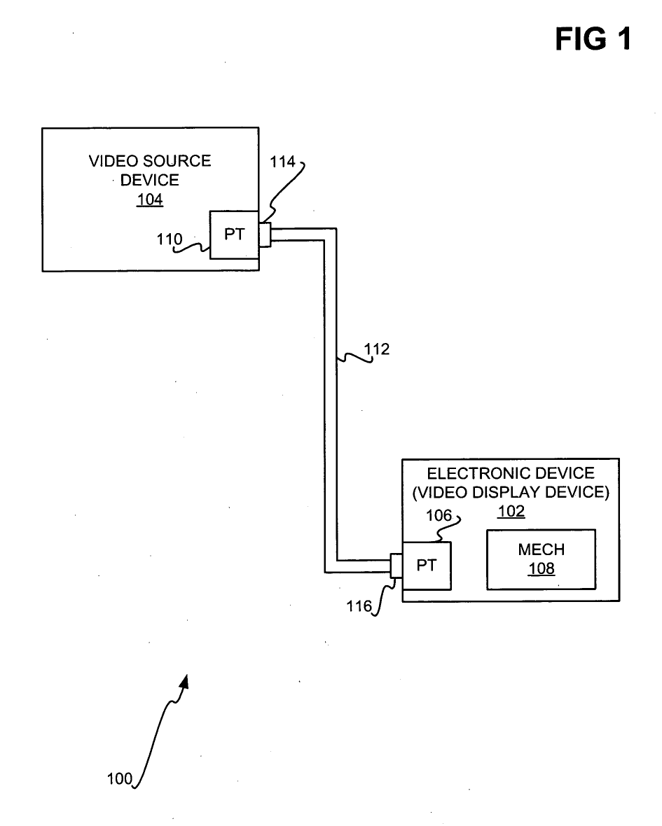

FIG. 1 shows a system 100, according to an embodiment of the invention. The system 100 includes an electronic device 102 and a video source device 104 communicatively coupled to one another via a cable 112. The electronic device 102 may specifically be a video display device. Examples of video display devices include projectors, flat-panel displays, plasma displays, liquid crystal displays (LCD's), as well as other types of video display devices. The electronic device 102 may further be a type of electronic device other than a video display device.

The video source device 104 is capable of outputting a video signal for input to the electronic device 102, such as for display on or by the electronic device 102. The video source device 104 may be a computer, such as a desktop, laptop, or notebook computer. The video source device 104 may also be a different type of video source device, such as a cable or satellite television set-top box, a digital versatile disc (DVD) player, a videocassette playing device, or another type of video source device.

As depicted in FIG. 1, in one embodiment the video source device 104 has an output port 110 to which one connector 114 of the cable 112 is connected. Likewise, the electronic device 102 has an input port 106 to which another connector 116 of the cable 112 is connected. The ports 106 and 110 may be VGA ports, composite video ports, s-video ports, component video ports, or other types of ports over which video signals are capable of being transmitted. The port 110 of the video source device 104 is an output port because video signals are capable of being output by the video source device 104 at the port 110. Similarly, the port 106 off the electronic device 102 is an input port because video signals are capable of being input to the electronic device 102 at the port 106.

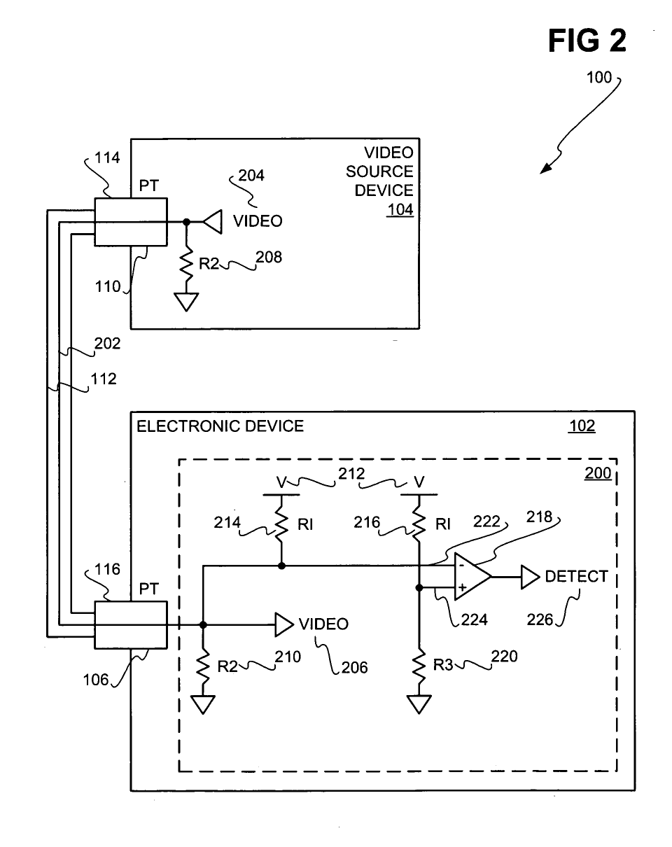

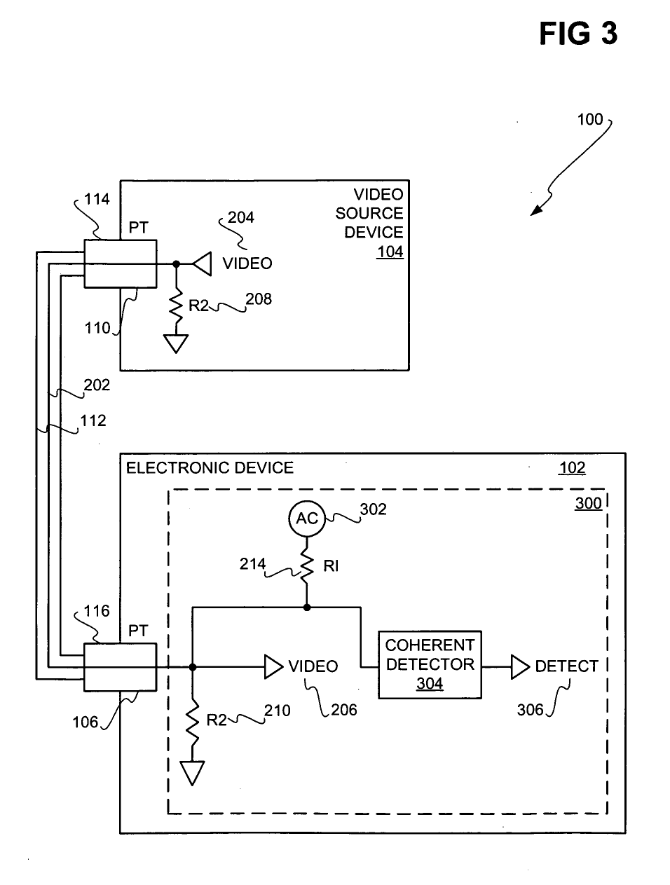

The electronic device 102 includes a mechanism 108 that is capable of detecting whether the video source device 104 is communicatively coupled or connected to the electronic device 102, even when the video source device 104 is not currently outputting a video signal for input to the electronic device 102. More specifically, the mechanism 108 is capable of detecting whether the cable 112 has its connectors 114 and 116 connected to the ports 110 and 106 of the devices 104 and 102, respectively, even when the video source device 104 is not currently outputting a video signal onto the port 110, such that the port 116 is not currently inputting a video signal. Such detection may be accomplished by detecting a resistance at the port 110 of the video source device 104, by detecting a change in current and/or a change in impedance when the video source device 104 is communicatively coupled to the electronic device 102, or by another approach. Two different embodiments of the mechanism 108 are now described with reference to FIGS. 2 and 3.

FIG. 2 shows a circuit 200 by which the electronic device 102 is able to detect whether the video source device 104 is communicatively connected thereto, when the video source device 104 is not currently outputting a video signal, according to an embodiment of the invention. The circuit 200 may be or be part of the mechanism 108 in one embodiment. For illustrative clarity and simplicity, one line 202 of the cable 112 is depicted in FIG. 2 as connecting the port 110 of the device 104 to the port 106 of the device 102, via the connectors 114 and 116, respectively. In actuality, there are typically more than one line within the cable 112 connecting the devices 104 and 102. However, just one such line is needed to detect whether the devices 104 and 102 are communicatively connected.

The line 202 is specifically that over which the video source device 104 transmits at least part of the video signal output at the internal video output 204, through the port 110 being connected to the connector 114 of the cable 112. For instance, where the ports 110 and 106 are VGA ports, and the cable 112 is a VGA cable, the line 202 may be one of the red, green, and blue lines over which red, green, and blue video signals are sent. The line 202, upon connection of the connector 114 of the cable 112 to the port 110 of the video source device 104, is customarily pulled down, such as to electrical or earth ground, via a resistor 208. The resistor 208 in one embodiment has a resistance of at least substantially 75 ohms. In other embodiments, the resistor 208 may have a resistance of 50 ohms, or a different resistance.

Similarly, at the electronic device 102, upon connection of,the connector 116 of the cable 112 to the port 106 of the device 102, is also pulled down, such as to electrical or earth ground, via a resistor 210. The resistor 210 also typically has a resistance of at least substantially 75 ohms. Preferably, the resistors 208 and 210 thus have the same resistance. The video signal output by the video source device 104 is thus input into the electronic device 102, to the internal video input 206.

The circuit 200 generally is able to determine whether the video source device 104 is communicatively connected to the electronic device 102, even when the video source device 104 is not currently outputting a video signal, by detecting the resistance at the internal video input 206. When the video source device 104 is not connected to the electronic device 102, the resistance at the internal video input 206 is at least substantially equal to the resistance of the resistor 210, such as 75 ohms. When the video source device 104 is connected to the electronic device 102, the resistance at the internal video input 206 is at least substantially equal to the resistance of the resistor 210 in parallel with the resistance of the resistor 208, or 37.5 ohms.

The circuit 200 includes a voltage source 212 that creates a voltage through the resistor 210, and through the resistor 208 when the video source device 104 is connected to the electronic device 102. The voltage source 212 is a direct current (DC) voltage source. A pull-up resistor 214 is present to limit the amount of current driven back through the line 202 of the cable 112 and to the internal video output 204 of the video source device 104. As such, the pull-up resistor 214 has a resistance that is substantially larger than the resistances of the resistors 210 and 208. For example, the resistance of the pull-up resistor 214 may be 10,000 ohms. In this way, the resistor 214 has a resistance that is sufficiently larger than the resistances of the resistors 210 and 208 so as to minimize disturbance to the signal being output at the internal video output 204.

The circuit 200 includes a comparator 218, having inputs 222 and 224. The comparator 218 may in one embodiment by an operational amplifier (op amp). The input 222 is tied to the internal video input 206 and the input port 106, such that the voltage over the internal video input 206 and the input port 106 is input to the input 222 of the comparator 218. The voltage source 212 also drives a voltage through a resistor 220 which is pulled down, such as to earth or electrical ground. The voltage over the resistor 220 is input to the input 224 of the comparator 218. A pull-up resistor 216 is also present to limit the amount of current driven through the resistor 220. The resistor 216 may in one embodiment have a resistance that is at least substantially equal to the resistance of the resistor 214.

The voltage over the resistor 220 and input to the input 224 of the comparator 218 is a reference voltage, and is constant. By comparison, the voltage at the internal video input 206 and input to the input 222 of the comparator 218 varies depending on whether the video source device 104 is connected to the electronic device 102. That is, the voltage at the internal video input 206 varies depending on whether the resistor 210 is alone, or is in parallel with the resistor 208 of the video source device 104.

Therefore, the resistance of the resistor 220 is selected so that the voltage at the input 224 of the comparator 218 is greater than the voltage at the internal video input 206 when the resistor 210 is not in parallel with the resistor 208, and is less than the voltage at the internal video input 206 when the resistor 210 is in parallel with the resistor 208. In one embodiment, the resistance at the internal video input 206 is 75 ohms when the video source device 104 is not connected to the electronic device 102, and is 37.5 ohms when the video source device 104 is connected to the electronic device 102. In this embodiment, the resistance of the resistor 220 may be selected at a value halfway between 37.5 ohms and 75 ohms, or substantially 56.25 ohms. In general, the resistance of the resistor 220 can in one embodiment be 75% of the resistances of the resistors 210 and 208.

When the voltage at the input 224 of the comparator 218 is greater than the voltage at the input 222 of the comparator 218, the output 226 of the comparator 218 has one value, and when the voltage at the input 224 of the comparator 218 is less than the voltage at the input 222 of the comparator 218, the output 226 of the comparator 218 has another value. Thus, the output 226 of the comparator 218 is indicative of whether the video source device 104 is communicatively connected to the electronic device 102, when the video source device 104 is not currently driving or outputting a video signal to the electronic device 102. The circuit 200 is able to make this detection based on the resistor 208 at the output port 110 of the video source device 104 being in parallel with the resistor 210 at the input port 106 of the electronic device 102.

FIG. 3 shows another circuit 300 by which the electronic device 102 is able to detect whether the video source device 104 is communicatively connected thereto, when the video source device 104 is not currently outputting a video signal, according to an embodiment of the invention. The circuit 300 may be or be part of the mechanism 108 in one embodiment. As in FIG. 2, for illustrative clarity and simplicity, one line 202 of the cable 112 is depicted in FIG. 3 as connecting the port 110 of the device 104 to the port 106 of the device 102, via the connectors 114 and 116, respectively. In actuality, there are typically more than one line within the cable 112 connecting the devices 104 and 102.

The circuit 300 of FIG. 3 generally operates in the same way as the circuit of FIG. 2 does, and like-numbered components between FIGS. 2 and 3 operate at least substantially identically in both figures, and are not redescribed in reference to FIG. 3 to avoid descriptive redundancy. The difference between the circuit 300 of FIG. 3 and the circuit 200 of FIG. 2 is primarily that the latter circuit uses a DC voltage to detect whether the video source device 104 is connected to the electronic device 102, based on the difference in the resistance 210 alone and the resistances 208 and 210 in parallel. By comparison, the circuit 300 of FIG. 3 uses an AC signal to detect whether the video source device 104 is connected to the electronic device 102, also based on the difference in the resistance 210 alone and the resistances 208 and 210 in parallel, as is now described.

In the circuit 300, an alternating current (AC) signal generator 302 generates and sends an AC signal through the resistor 210 alone, when the video source device 104 is not connected to the electronic device 102, and through the resistors 208 and 210 in parallel, when the video source device 104 is connected to the electronic device 102. The AC signal may be a sine wave, a square wave, or another type of AC signal. The coherent detector 304 detects the signal at the internal video input 206 of the electronic device 102. The coherent detector 304 is able to detect the AC signal at the internal video input 206 as either corresponding to the just the resistor 210 being present in the electrical path, or both the resistor 208 and the resistor 210 in parallel. While the coherent detector 304 may be desired for precise detection of the AC signal, more generally the coherent detector 304 is a detector, such that detection of the AC signal may be coherent or non-coherent detection.

Therefore, based on how the coherent detector 304 is detected, the output 306 of the coherent detector 304 changes. The output 306 of the detector 304 is thus indicative of whether the video source device 104 is communicatively connected to the electronic device, when the video source device 104 is not currently driving or outputting a video signal to the electronic device. The circuit 300 is able to make this detection based on the resistor 208 at the output port of the video source device 104 being in parallel with the resistor 210 at the input port 106 of the electronic device 102.

As can be appreciated by those of ordinary skill within the art, coherent detection typically involves detecting the interference of a signal with a reference signal, and thus the coherent detector 304 may be considered a heterodyne receiver. Just the portion of the AC signal at the internal video input 206 (viz., at the input port 106) coherent with the locally, or internally, generated signal is detected. The portion of the AC signal at the internal video input 206 that is coherent varies depending on whether just the resistor 210 is in the electrical path from the AC signal generator 302, or both the resistor 210 and the resistor 208 are in parallel within the electrical path from the AC signal generator 302. In this way, the coherent detector 304 is able to detect whether or not the video source device 104 is communicatively connected to the electronic device 102.

One advantage of employing the AC-oriented circuit 300 of FIG. 3 instead of the DC-oriented circuit 200 of FIG. 2 is that the AC signals used in the circuit 300 can be of smaller magnitude than the DC voltages used in the circuit 200. As a result, there is less likelihood of adversely affecting the video source device 104 when using the circuit 300. Furthermore, because the circuit 300 uses AC signals instead of DC voltages, it is less likely to affect any sort of DC offset that may be present within the video signal transmitted by the video source device 104. The coherent detector 304 of the circuit 300 may further be a more sophisticated electronic component than the comparator 218 of the circuit 200 is, such that the circuit 300 can be more sensitive to the detection of the connection of the video source device 104 to the electronic device 102 than the circuit 200 is.

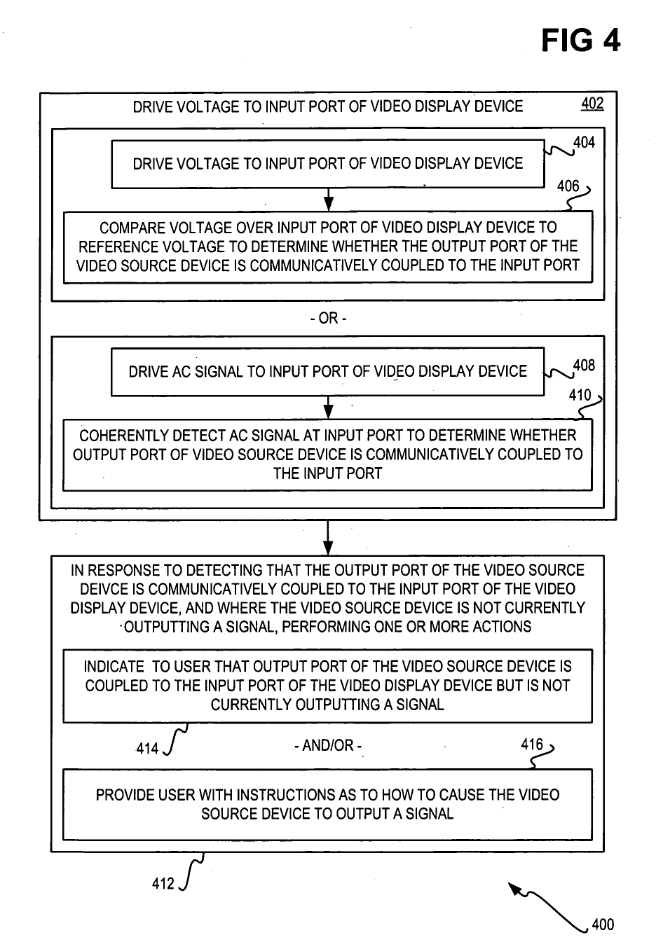

FIG. 4 shows a method 400, according to an embodiment of the invention. At least some parts of the method 400 may be implemented as parts of a computer program stored on a computer-readable medium. For example, the computer program parts may be software objects, subroutines, routines, and so on. The computer-readable medium may be a removable or a non-removable medium, and a volatile or a non-volatile medium. The medium may be a semiconductor medium, such as a memory, a magnetic medium, such as a hard disk drive or a floppy disk, and/or an optical medium, such as a CD or a DVD.

It is noted that in at least some embodiments of the invention, the method 400 is performed after it has been detected that a signal is not present at the input port of a video display device. Thereafter, the method 400 begins by detecting whether the output port of a video source device is communicatively coupled to an input port of a video display device (402), such as via a cable. The detection is based on a resistance at the output port being in parallel with a resistance at the input port when the two devices are communicatively connected, as has been described in relation to FIGS. 2 and 3. Therefore, in one embodiment, such detection is accomplished as has been described in relation to FIG. 2. A DC voltage is driven to or at the input port of the video display device (404), and the voltage over the input port is compared against a reference voltage to determine whether the output port of the video source device is connected to the input port (406).

In another embodiment, the detection is accomplished as has been described in relation to FIG. 3. An AC signal is driven to or at the input port of the video display device (408). The AC signal at the input port is then coherently detected to determine whether the output port of the video source device is connected to the input port of the video display device (410).

Next, where it has been detected that the output port of the video source device is communicatively coupled to the input port of the video display device, and where the video source device is not currently outputting a video signal, one or more actions are performed (412). In the case where the video source device is a portable computer, like a laptop or a notebook computer, such actions may include 414, 416, or both 414 and 416. Other actions may further be performed, in addition to and/or in lieu of 414 and/or 416.

First, the user may be indicated that the output port of the video source device is coupled to the input port of the video display device, but that the video source device is not currently outputting a signal (414). For instance, the video display device may display or project such information to the user. Second, the user may be provided with instructions as to how to cause the video source device to output a signal (416). For instance, the video display device may display or project instructions that pressing a particular key sequence on the portable computer, such as Fn-F5, is typically employed to cause the computer to output a signal on the VGA port thereof.

It is noted that, although specific embodiments have been illustrated and described herein, it will be appreciated by those of ordinary skill in the art that any arrangement is calculated to achieve the same purpose may be substituted for the specific embodiments shown. This application is intended to cover any adaptations or variations of the present invention. Therefore, it is manifestly intended that this invention be limited only by the claims and equivalents thereof.

We claim:

1. A method comprising:
detecting by a video display device whether an output port of a video source device is communicatively coupled to an input port of the video display device, based on detecting a resistance at the output port of the video source device; and,
in response to detecting that the output port of the video source device is communicatively coupled to the input port of the video display device, and where the video source device is not currently outputting a signal at the output port, performing one or more actions by the video display device.

2. The method of claim 1, wherein detecting whether the output port of the video source device is communicatively coupled to the input port of the video display device is based on detecting the resistance at the output port of the video source device being in parallel with a resistance at the input port of the video display device.

3. The method of claim 1, wherein detecting by the video display device whether the output port of the video source device is communicatively coupled to the input port of the video display device comprises:
driving a voltage from the video display device to the input port thereof; and,
comparing a voltage over the input port of the video display device to a reference voltage to determine whether the output port of the video source device is communicatively coupled to the input port,
wherein the voltage over the input port varies based on whether the output port of the video source device is communicatively coupled to the input port of the video display device.

4. The method of claim 1, wherein detecting by the video display device whether the output port of the video source device is communicatively coupled to the input port of the video display device comprises:
driving an alternating current (AC) signal from the video display device to the input port thereof; and,
detecting the AC signal at the input port of the video display device to determine whether the output port of the video source device is communicatively coupled to the input port,
wherein the AC signal at the input port varies based on whether the output port of the video source device is communicatively coupled to the input port of the video display device.

5. The method of claim 4, wherein detecting the AC signal at the input port comprises coherently detecting the AC signal at the input port.

6. The method of claim 1, wherein performing the one or more actions by the video display device comprises at least one of:
indicating to a user of the video display device that the output port of the video source device is communicatively coupled to the input port of the video display device but that the video source device is not currently outputting a signal at the output port; and,
providing the user with instructions as to how to cause the video source device to output a signal at the output port of the video source device.

7. The method of claim 1, wherein the video source device is a portable computing device, the video display device is a projector, and the resistance at the output port of the video source device and a resistance at the input port of the video display are each equal to at least substantially 75 ohms.

8. A circuit at an input port of a video display device to determine whether an output port of a video source device is communicatively coupled to the input port, the circuit comprising:
a comparator having a first input, a second input, and an output, the first input coupled to the input port of the video display device, the output changing depending on whether the output port of the video source device is communicatively coupled to the input port of the video display device;
a first resistive mechanism coupled between the first input of the comparator and ground, the first resistive mechanism being in parallel with a resistive mechanism at the output port of the video source device when the output port of the video source device is communicatively coupled to the input port of the video display device;
a second resistive mechanism coupled between the second input of the comparator and ground; and,
a voltage source to drive a voltage through the first resistive mechanism and a voltage through the second resistive mechanism.

9. The circuit of claim 8, further comprising:
a third resistive mechanism in series with the first resistive mechanism and coupled between the voltage source and the first input of the comparator; and,
a fourth resistive mechanism in series with the second resistive mechanism and coupled between the voltage source and the second input of the comparator,
wherein the third resistive mechanism has a resistance sufficiently larger than a resistance of the first resistive mechanism to minimize disturbance to a signal being sent from the output port of the video source device to the input port of the video display device.

10. The circuit of claim 9, wherein the resistance of the third resistive mechanism is at least substantially equal to a resistance of the fourth resistive mechanism.

11. The circuit of claim 8, wherein the first resistive mechanism has a resistance that is at least substantially equal to a resistance of the resistive mechanism at the output port of the video source device.

12. The circuit of claim 8, wherein the second resistive mechanism has a resistance selected such that the output of the comparator changes depending on whether the output port of the video source device is communicatively coupled to the input port of the video display device.

13. The circuit of claim 8, wherein each of the first and the second resistive mechanisms comprises at least one resistor.

14. The circuit of claim 8, wherein the voltage source is a direct current (DC) voltage source.

15. The circuit of claim 8, wherein the comparator comprises an operational amplifier (op amp).

16. A circuit at an input port of a video display device to determine whether an output port of a video source device is communicatively coupled to the input port, the circuit comprising:
an alternating current (AC) signal source to output an alternating current;
a resistive mechanism coupled between the AC signal source and ground, the resistive mechanism being in parallel with a resistive mechanism at the output port of the video source device when the output port of the video source device is communicatively coupled to the input port of the video display device; and,
a detector coupled to the resistive mechanism and capable of detecting a signal corresponding to when the output port of the video source device is communicatively coupled to the input port of the video display device.

17. The circuit of claim 16, wherein the AC signal source outputs one of: a sine wave, and a square wave, and the resistive mechanism comprises one or more resistors.

18. The circuit of claim 16, wherein the detector is a coherent detector.

19. An electronic device comprising:
an input port receptive to a cable communicatively coupled to an output port of a video source device; and,
a mechanism to detect whether the input port is communicatively coupled to a cable communicatively coupled to the output port of the video source device, based on detecting a resistance at the output port of the video source device, where the video source device is not currently driving a signal at the output port.

20. The electronic device of claim 19, wherein the mechanism is to detect whether the input port is communicatively coupled to a cable communicatively coupled to the output port based on detecting the resistance at the output port being in parallel with a resistance at the input port.

21. The electronic device of claim 19, wherein the input port comprises one of: a VGA port, a component video port, a composite video port, and an s-video port.

22. The electronic device of claim 19, wherein the mechanism comprises a resistive mechanism coupled between a pin of the input port and ground, the resistive mechanism providing a resistance at the input port that is in parallel with the resistance at the output port of the video source device when the input port is communicatively coupled to a cable communicatively coupled to the output port of the video source device.

23. The electronic device of claim 22, wherein the mechanism further comprises:
a comparator having a first input, a second input, and an output, the first input coupled to the pin of the input port to which the resistive mechanism is coupled, the output changing depending on whether the input port is communicatively coupled to a cable communicatively coupled to the output port of the video source device;
another resistive mechanism coupled between the second input of the comparator and ground and having a resistance selected such that the output of the comparator changes depending on whether the input port is communicatively coupled to a cable communicatively coupled to the output port of the video source device; and,
a voltage source to drive a voltage through both of the resistive mechanisms.

24. The electronic device of claim 22, wherein the mechanism further comprises:
an alternating current (AC) signal source to output an alternating current; and,
a detector coupled to the resistive mechanism and capable of detecting a signal corresponding to when the input port is communicatively coupled to a cable communicatively coupled to the output port of the video source device.

25. The electronic device of claim 19, wherein the electronic device is a video display device.

26. An electronic device comprising:
means for receiving a cable communicatively coupled to an output port of a video source device; and,
means for detecting whether the means for receiving is communicatively coupled to a cable communicatively coupled to the output port of the video source device, based on detecting a resistance at the output port, where the video source device is not currently driving a signal at the output port.

27. The electronic device of claim 26, wherein the means for detecting is further for driving a voltage to the means for receiving and for comparing a voltage over the means for receiving to a reference voltage to determine whether the means for receiving is communicatively coupled to a cable communicatively coupled to the output port of the video source device.

28. The electronic device of claim 26, wherein the means for detecting is further for driving an alternating current (AC) signal to the means for receiving and for detecting the AC signal at the means for receiving to determine whether the means for receiving is communicatively coupled to a cable communicatively coupled to the output port of the video source device.

29. A computer-readable medium having a computer program stored thereon comprising:
a first computer program part to receive indication from a circuit of a video display device as to whether an output port of a video source device is communicatively coupled to an input port of the video display device, the circuit detecting whether the output port of the video source device is communicatively coupled to the input port of the video display device based on detecting a resistance at the output port; and,
a second computer program part to perform one or more actions in response to the indication from the circuit that the output port of the video source device is communicatively coupled to the input port of the video display device, and where the video source device is not currently outputting a signal at the output port.

30. The computer-readable medium of claim 29, wherein the circuit detects whether the output port is communicatively coupled to the input port based on detecting the resistance at the output port being in parallel with a resistance at the input port.

31. The computer-readable medium of claim 29, wherein the one or more actions performed by the second computer program part comprise at least one of:
indicating to a user of the video display device that the output port of the video source device is communicatively coupled to the input port of the video display device but that the video source device is not currently outputting a signal at the output port; and,
providing the user with instructions as to how to cause the video source device to output a signal at the output port of the video source device.
